(19) United States
(12) Patent Application Publication
(10) Pub. No.: US 2024/0035616 A1
(43) Pub. Date: Feb. 1, 2024

(54) CLEANING TOOL FOR GREASE FITTING

(71) Applicant: LIJIANG SUN, Hangzhou (CN)

(72) Inventors: LIJIANG SUN, Hangzhou (CN); HUABING HAN, Hangzhou (CN)

(21) Appl. No.: 18/225,888

(22) Filed: Jul. 25, 2023

(30) Foreign Application Priority Data
Jul. 28, 2022 (CN) 202221961460.7
Jul. 12, 2023 (CN) 202321827406.8

(51) Int. Cl. F16N 33/00; B08B 1/04; B08B 1/00

(52) U.S. Cl. CPC F16N 33/00; B08B 1/04; B08B 1/005

(57) ABSTRACT

The present invention relates to the technical field of grease fitting cleaning tools, in particular to a cleaning tool for a grease fitting. The cleaning tool for a grease fitting provided by the present invention is structurally characterized by including a hand-held portion and a cleaning portion, where the hand-held portion and the cleaning portion are integrally formed. A worker holds the hand-held portion and cleans the grease fitting through the cleaning portion. The tool has the advantages of a simple structure, a low cost, and convenient wide-range promotion and use.

### CROSS-REFERENCE TO RELATED APPLICATIONS

This is a U.S. patent application which claims the priority and benefit of Chinese Patent Application Number 20232182406. 8, filed on Jul. 12, 2023, and Number 202221961460. 7, filed on Jul. 28, 2022, disclosure of which is incorporated herein by reference in its entirety.

### TECHNICAL FIELD

The present invention relates to the technical field of grease fitting cleaning tools, in particular to a cleaning tool for a grease fitting.

### BACKGROUND

A grease fitting is mainly used for connecting a grease gun and a mechanical apparatus, and facilitates subsequent filling of the mechanical apparatus with grease by using a grease gun. However, after grease filling, a large amount of grease residues are likely to be accumulated on the grease fitting, which affects elasticity of a ball, hinders smooth grease filling, and causes the next grease injection to be troublesome.

In order to solve the above problems, some improved products are developed and put on the market. For example, as disclosed in the patent CN202120610569.5, a dirt-proof easy-to-fill grease fitting includes a housing and a guide cover, where the guide cover is detachably connected to the housing, a diameter of the guide cover gradually increases in a direction of getting far away from the housing from a position close to the housing, the housing is provided with a grease filling through recess, the grease filling through recess includes a grease filling port, a hole plugging ball is arranged at the grease filling port, and the hole plugging ball is located in the guide cover. The guide cover is detachably connected to the housing, the guide cover is adapted to the grease gun, the hole plugging ball is arranged at the grease filling port, a guide inlet of the guide cover is opened or closed through an opening and closing portion arranged in the guide cover, so as to prevent external dirt from entering the guide cover and a nozzle of the grease fitting. Residual grease at the guide cover and the nozzle of the grease fitting is removed through a cleaning portion arranged in the guide cover, so as to ensure smooth grease filling and prevent the dirt from wearing mechanical parts.

However, e above technical solution makes a structure of the grease fitting complicated and increases its manufacturing cost. An existing grease fitting is generally a standard part, and its popularization is difficult to some extent, making it necessary to develop a cleaning tool for the grease fitting.

### SUMMARY

A main objective of the present invention is to overcome shortcomings in the prior art and provide a cleaning tool for a grease fitting. The tool has the advantages of a simple structure, a low cost, and convenient wide-range promotion and use.

A technical solution used by the present invention for achieving the technical objective is as follows: a cleaning tool for a grease fitting is structurally characterized by including a hand-held portion and a cleaning portion, where the hand-held portion and the cleaning portion are integrally formed. A worker holds the hand-held portion and cleans the grease fitting through the cleaning portion.

The cleaning portion is arranged at one end of the hand-held portion, a center of an end face of the cleaning portion is provided with a press bump, the periphery of the press bump is provided with several cleaning claws, the press bump presses a ball of a plug hole of the grease fitting, and the cleaning claw has a longer length than the press bump for cleaning the grease fitting. By pressing the press bump, the hole plugging ball is pressed to move, so as to prevent the ball from being plugged by residual grease and dirt and avoid influence on normal movement of the ball.

An inner side of a cleaning claw is a cambered surface, and fits a shell of the grease fitting in shape. The cleaning claw cleans an outer surface of the grease fitting, and scraps the remaining grease and dirt off the outer surface.

Preferably, at least two cleaning claws are provided, and cambered surfaces are arranged to incline in the same direction in an axial direction.

Preferably, the cambered surfaces include a first cambered surface and a second cambered surface connected to the first cambered surface, the first cambered surface extends away from an axis in a direction far away from the hand-held portion, and the second cambered surface extends close to the axis in the direction far away from the hand-held portion.

Preferably, the cleaning claws are arranged to incline in the same direction. in the axial direction.

Preferably, an end, far away from the hand-held portion, of the cleaning claw is provided with an inclined surface.

Preferably, the other end, relative to the cleaning portion, of the hand-held portion is provided with a hollowed interior, and a hexagonal inner hole is provided inside the hollowed interior. The hexagonal inner hole can be used as a wrench to tighten or loosen the grease fitting, such that more comprehensive functions are achieved, use by the worker is facilitated and wide-range promotion and use of the tool are facilitated.

Preferably, at least three cleaning claws are provided, and the cleaning claws are symmetrically arranged and uniformly arranged at the periphery of a press bump. The cleaning claw can be conveniently clamped on the grease fitting and attached to the outer surface of the grease fitting for cleaning.

Preferably, the hand-held portion has a round appearance, and is simple in structure and low in manufacturing cost. The cleaning portion is provided with a transverse beam, and the press bump is arranged in a center of the beam, such that the press bump is arranged more stably.

Preferably, an outer surface of the hand-held portion is provided with raised strips, and the raised strips are uniformly arranged on the outer surface of the hand-held portion peripherally. Friction force of the hand-held portion can be increased, holding and cleaning by the worker are facilitated and slipping is avoided.

Preferably, the hand-held portion has a hexagonal appearance, holding and cleaning by the worker are facilitated and slipping is avoided. The cleaning portion is provided with a transverse beam, and the press bump is arranged in a center of the beam, such that the press bump is arranged more stably.

Preferably, the cleaning tool for a grease fitting further includes an extension portion, where one end of the extension portion is detachably arranged in the hexagonal inner hole, the other end of the extension portion is connected to a press portion, and under the condition that the press portion moves close to the hand-held. portion, the extension portion rotates into the press portion.

Preferably, an interior of the press portion is hollowed, an inner wall of the press portion is provided with a plurality of spiral portions, an extension portion is provided with a rotary portion, and the rotary portion moves along the spiral portion and drives the extension portion to rotate.

Preferably, the rotary portion includes a convex ring, a movable protrusion is arranged in a peripheral direction of the convex ring, a spring is further arranged inside the press portion, and an end of the spring sleeves the extension portion.

Preferably, the press portion and the hand-held portion are connected to each other through a snap fastener, a lamp is arranged at an end, close to the hand-held portion, of the press portion, and a switch for controlling the lamp is further arranged. on the press portion.

The present invention has the following beneficial effects:

According to the present invention, through design of the hand-held portion and the cleaning portion, holding by the worker for cleaning the grease fitting is facilitated, and the phenomenon that the grease and dirt on the grease fitting are accumulated thereon and smooth oil filling is influenced is prevented. In addition, design of the hexagonal inner hole at the other end can be used as the wrench of the grease fitting, such that the various functions and more convenient use are achieved. The cleaning tool has a simple overall structure and a low manufacturing cost, and is conducive to wide-range promotion and use.

According to the present invention, the extension portion is matched with. the press portion, and when the press portion is pressed, the extension portion drives the cleaning portion to rotate, such that cleaning is faster and more efficient, and cleaning is performed without manually rotating the hand-held portion.

### BRIEF DESCRIPTION OF DRAWINGS

FIG. 1 is a schematic diagram of an overall structure of a cleaning tool for a grease fitting according to Example 1 of the present invention.

FIG. 2 is a schematic structural diagram of a cleaning portion of a cleaning tool for a grease fitting according to the present invention.

FIG. 3 is a sectional view of a cleaning tool for a grease fitting according to the present invention.

FIG. 4 is a diagram showing a use state of a cleaning tool for a grease fitting as a wrench according to the present invention.

FIG. 5 is a schematic diagram of an overall structure of a cleaning tool for a grease fitting according to Example 2 of the present invention.

FIG. 6 is a schematic diagram of an overall structure of a cleaning tool for a grease fitting according to Example 3 of the present invention.

FIG. 7-9 are schematic diagrams of an overall structure of a cleaning tool. for a grease fitting according to Example 4 of the present invention.

FIG. 10 is a schematic diagram of an expanded structure of a cleaning tool for a grease fitting according to Example 5 of the present invention.

FIG. 11 is a schematic structural diagram showing transportation of a cleaning tool for a grease fitting according to Example 5 of the present invention.

FIG. 12 is a schematic diagram showing an internal connection between a press portion and an extension portion of the cleaning tool for a grease fitting according to Example 5 of the present invention.

In the figures; 1, hand-held portion; 11, hexagonal inner hole; 12. raised strip; 2. cleaning portion.; 21, press bump; 22. cleaning claw; 221. inclined surface; 23. beam; 24. cambered surface; 241. first cambered surface; 242. second cambered surface; 3. grease fitting; 31. ball; 4. extension portion; 41. rotary portion; 411. convex ring; 412. movable protrusion; 5. press portion; 51. spiral portion; 52. spring; 6. snap fastener; 7. lamp; and 8. switch.

### DETAILED DESCRIPTION

To make objectives, technical solutions and advantages of the present invention clearer, the present invention will be further described in detail with reference to accompanying drawings and in conjunction with examples. It should be understood that particular examples described herein are merely used to explain the present invention, and are not used to limit the present invention. In addition, in the following description, descriptions of well-known structures and technologies are omitted to avoid unnecessary confusion of concepts of the present invention.

In the description of the present invention, it should be noted that when an element is described to be “fixed” or “arranged” on another element, the element can be located directly on the another element or indirectly on the another element. When an element is considered to be “connected” to another element, the element can be directly connected to another element or indirectly connected to another element.

In the description of the present invention, it should be noted that orientation or positional relations indicated by terms such as “center”, “length”, “width”, “thickness”, “up”, “down”, “front”, “back”, “left”, “right”, “vertical”, “horizontal”, “top”, “bottom”, “inside” and “outside” are based on an orientation or positional relation shown in the accompanying drawings, or are orientation or positional relations of common placement of the product during use of the present invention, are merely for facilitating description of the present invention and simplifying the description rather than indicating or implying that an apparatus or element referred to or implied must have a particular orientation or be constructed and operated in a particular orientation, and cannot be understood as limitation to the present invention as a result. In addition, terms such as “first”, “second” and “third” are merely used for distinguishing description and cannot be understood as indicating or implying relative importance. Therefore, the features defined with “first” and “second” can explicitly or implicitly include one or more features. In the description of the present invention, “plurality” means two or more than two, unless otherwise explicitly and specifically defined. The term “several” means one or more than one, unless otherwise explicitly and specifically defined.

In the description of the present invention, it should be further noted that, unless otherwise explicitly specified and defined, the terms such as “arrange”, “mount”, “connecting” and “connection” should be understood in a broad sense. For example, a connection can be a fixed connection, a detachable connection or an integrated connection, can be a mechanical connection or an electric connection., can be a direct connection or an indirect connection through an intermediate medium, and can be internal communication of two elements. For those of ordinary skill in the art, specific meanings of the above terms in the present invention can understood according to specific circumstances.

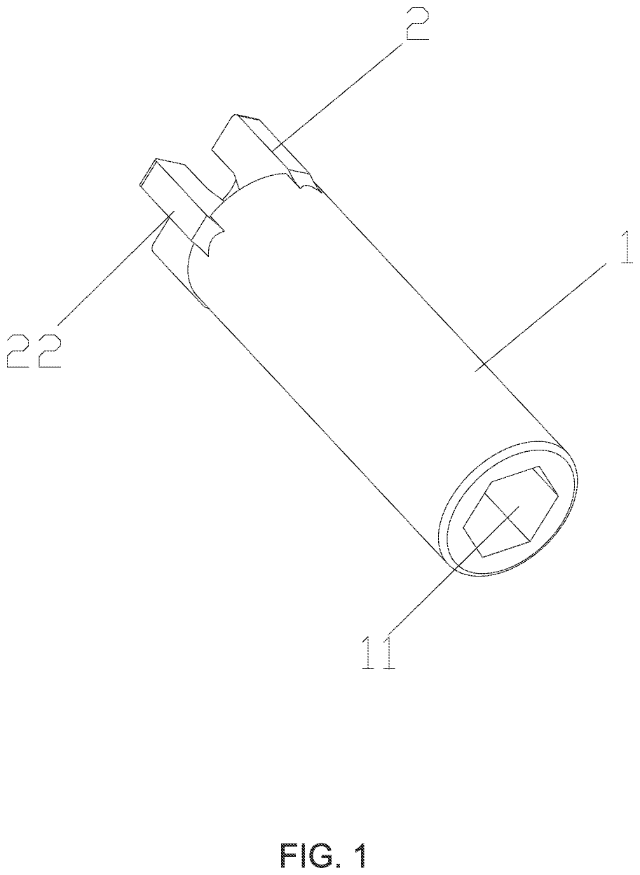

With reference to FIG. 1, as shown in the figure, in Example 1, a cleaning tool for a grease fitting includes a hand-held portion 1 and a cleaning portion 2, where the hand-held portion 1 and the cleaning portion 2 are integrally formed and made of materials such as plastic, and a worker holds the hand-held portion 1 to clean the grease fitting 3 through the cleaning portion 2.

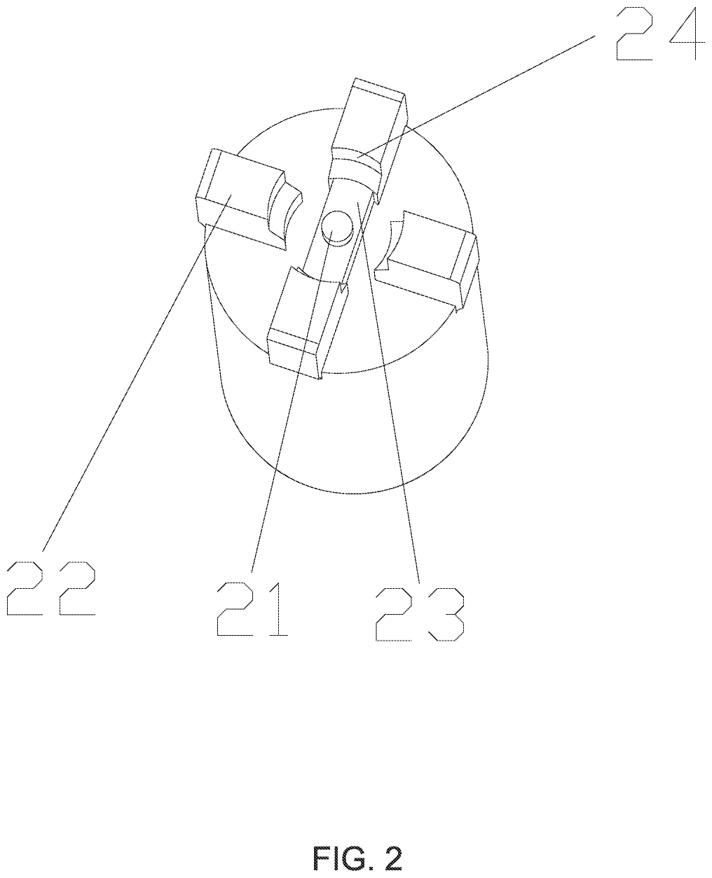

With reference to FIG. 2, as shown in the figure, the cleaning portion 2 is arranged at one end of the hand-held portion 1, a center of an end face of the cleaning portion 2 is provided with a press bump 21, and the periphery of the press bump 21 is provided with several cleaning claws 22. The press bump 21 presses a hole plugging ball 31 of the grease fitting 3, and the cleaning claw 22 has a longer length than the press bump 21. By pressing the press bump 21, the hole plugging ball 31 is pressed to move, so as to prevent the ball 31 from being plugged by residual grease and dirt and avoid influence on normal movement of the ball.

An inner side of a cleaning claw 22 is a cambered surface 24, and fits a shell of the grease fitting 3 in shape. The cleaning claw 22 cleans an outer surface of the grease fitting 3, and scraps the remaining grease and dirt off the outer surface.

The other end, relative to the cleaning portion 2, of the hand-held portion 1 is provided with a hollowed interior, and a hexagonal inner hole 11 is provided inside the hollowed interior. The hexagonal inner hole 11 can be used as a wrench to tighten or loosen the grease fitting 3, such that more comprehensive functions are achieved, use by the worker is facilitated and wide-range promotion and use of the tool are facilitated.

In this example, at least three cleaning claws 22 are arranged. Preferably; four cleaning claws are arranged, and made of plastic to prevent the grease fitting 3 from being worn during cleaning. The cleaning claws 22 are uniformly arranged at the periphery of the press bump 21, such that the cleaning claw 22 can be conveniently clamped on the grease fitting 3 and attached to the outer surface of the grease fitting 3 for cleaning.

In this example, the hand-held portion 1 has a round appearance, and is simple in structure and low in manufacturing cost. The cleaning portion 2 is provided with a transverse beam 23, and a press bump 21 is arranged in a center of the beam 23, such that the press bump 21 is arranged more stably.

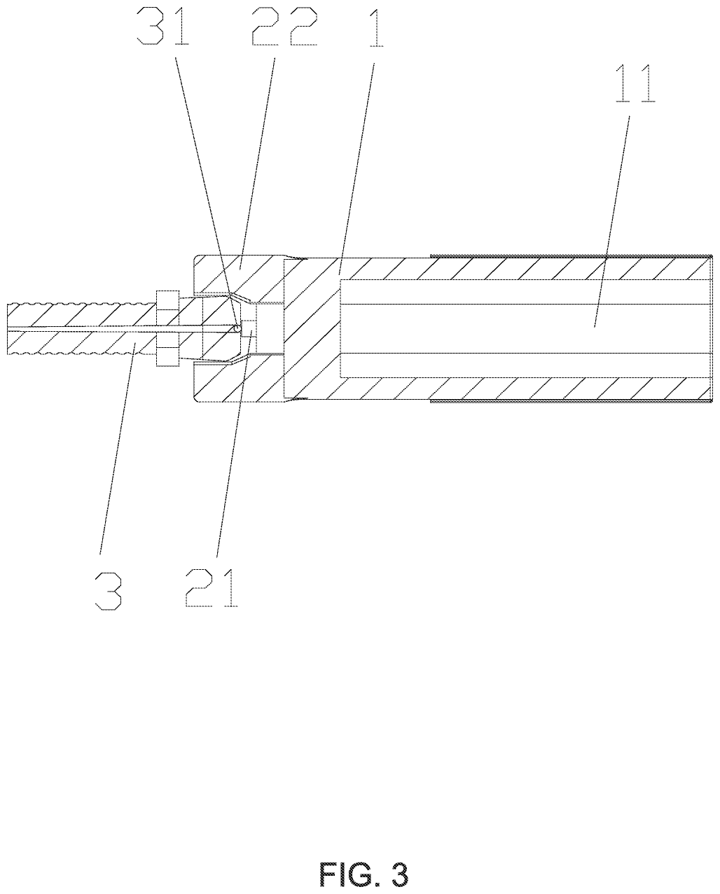

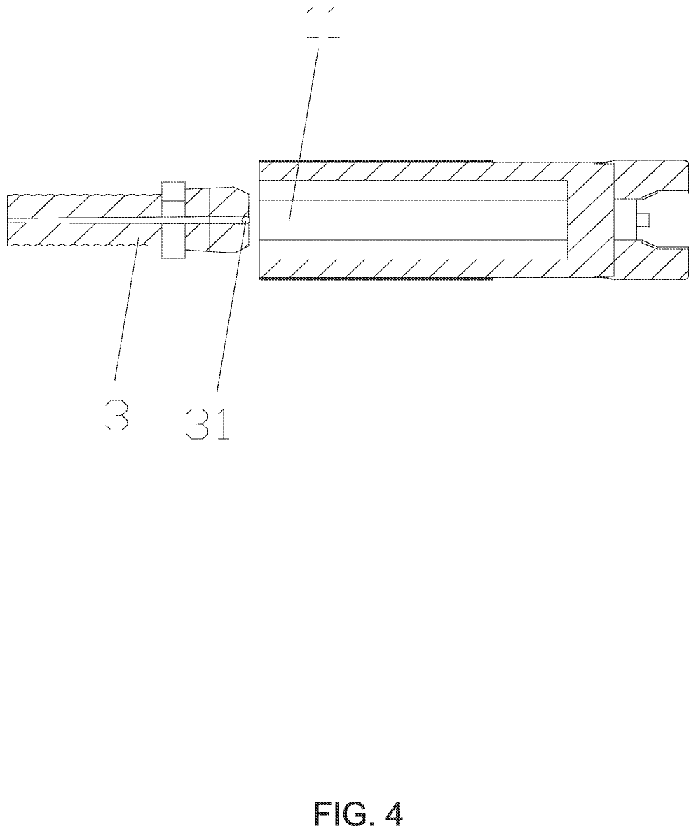

With reference to FIGS. 1, 2 and 3, specifically, during cleaning, a worker holds the hand-held portion 1, clamps the cleaning claws 22 at the periphery of the grease fitting 3, and scrapes residual grease and dirt off the outer surface of the grease fitting 3 through rotation of the cleaning claw 22. The cleaning tool can be moved back and forth at the same time, such that the press hump 21 presses the hole plugging ball 31 of the grease fitting 3 back and forth, the ball 31 moves smoothly and the ball 31 is prevented from being plugged. hi addition, with reference to FIG. 4, as shown in the figure, the worker holds the cleaning tool reversely, and the cleaning tool can be used as a wrench through the hexagonal inner hole 11 of the hand-held portion 1, such that various functions are achieved, and use by the worker is facilitated.

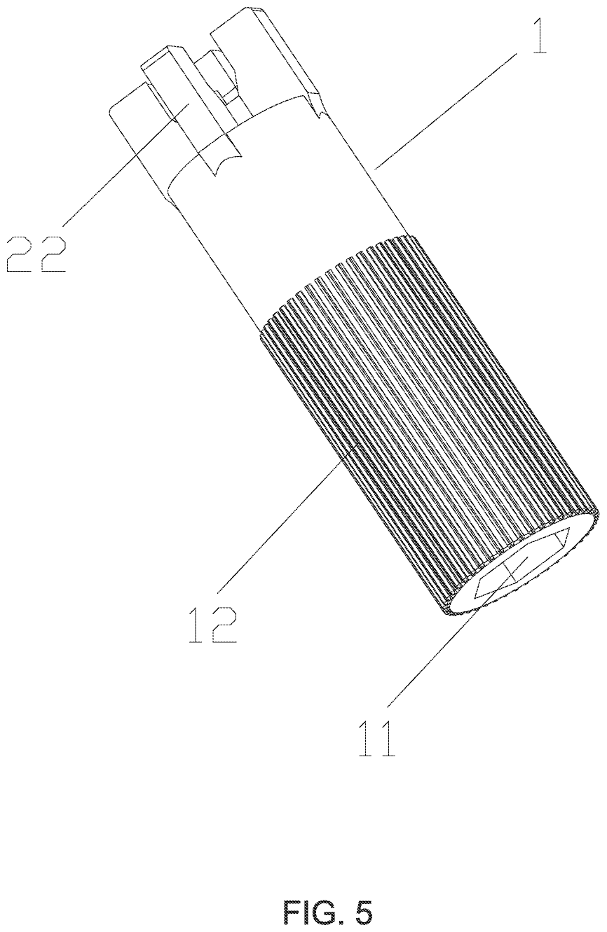

With reference FIG. 5, as shown in the figure, in Example 2, an outer surface of the hand-held portion 1 is provided with raised strips 12, and the raised strips 12 are uniformly arranged on the outer surface of the hand-held portion 1 peripherally, Compared with Example 1, according to this technical solution, friction force of the hand-held portion 1 can be increased, holding and cleaning by the worker are facilitated and slipping is avoided.

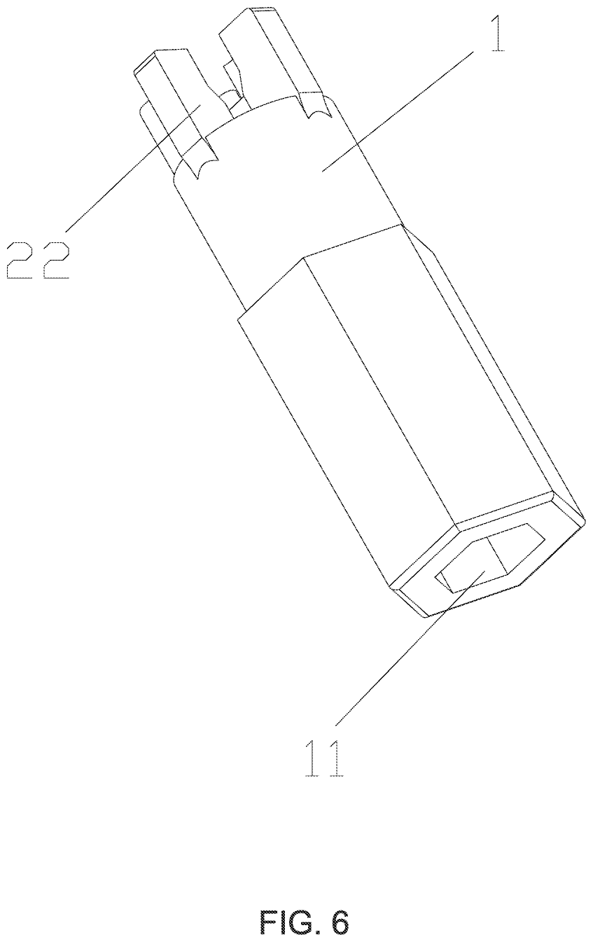

With reference to FIG. 6, as shown in the figure, in Example 3, the hand-held portion 1 has a hexagonal appearance. Compared with Example 1, holding and cleaning by a worker are facilitated, and slipping is prevented. Compared with Example 2, a simpler structure is achieved. The cleaning portion 2 is provided with a transverse beam 23, and a press bump 21 is arranged in a center of the beam 23, such that the press bump 21 is arranged more stably.

### EXAMPLE 4:

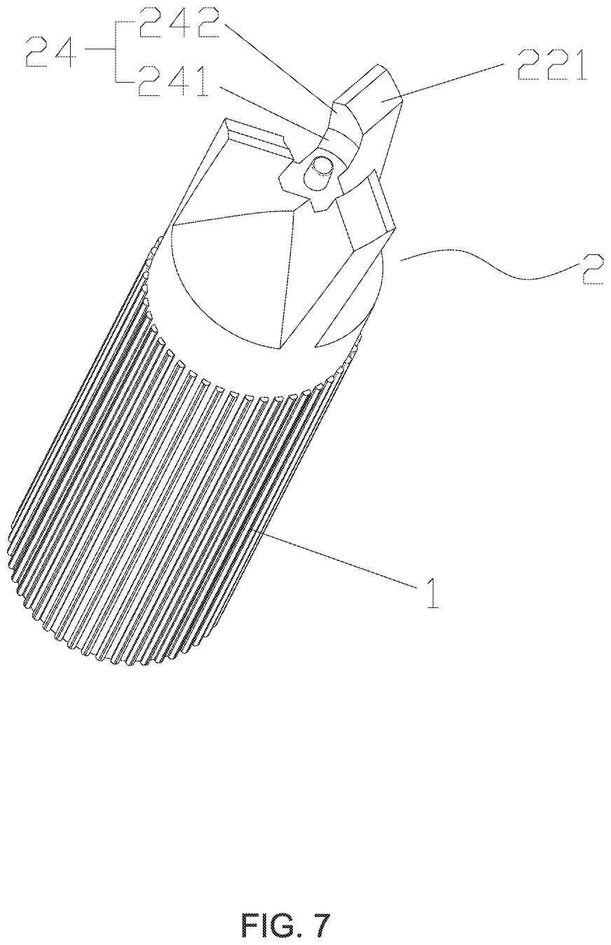

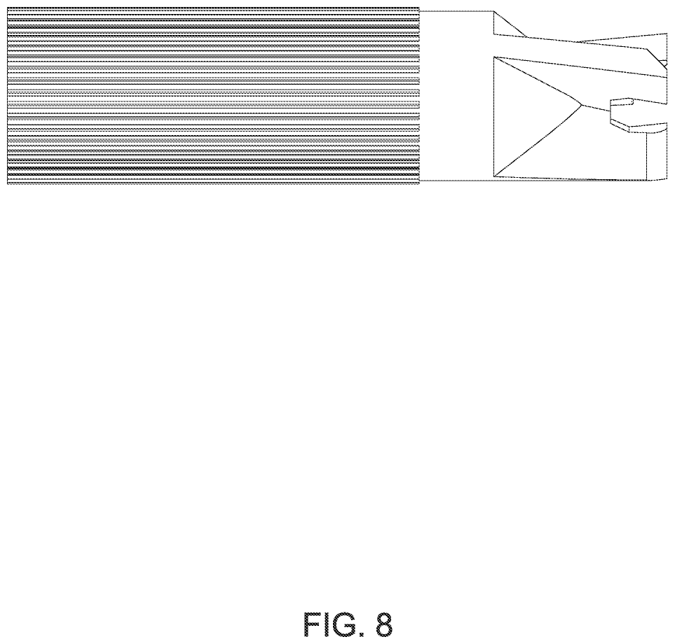

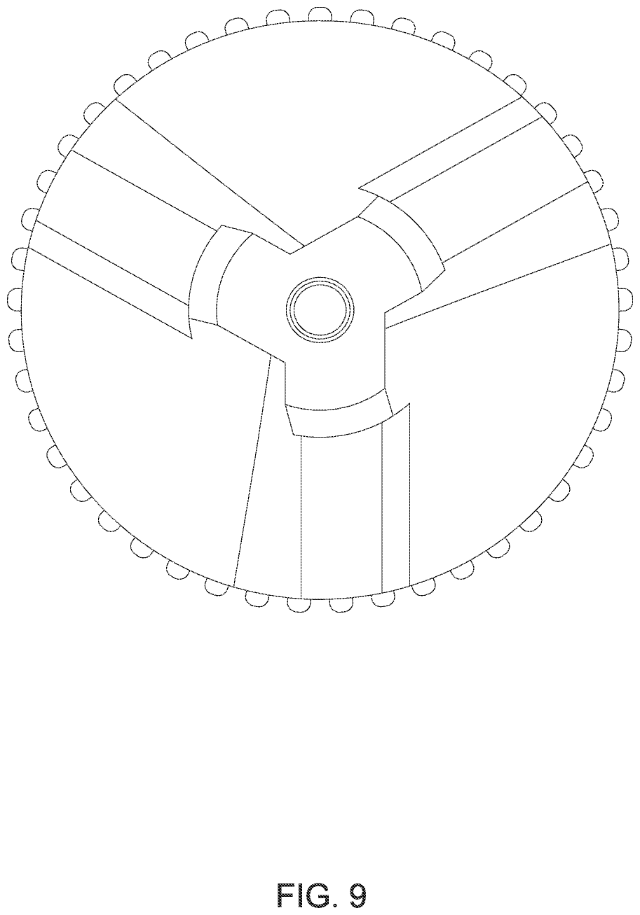

With reference to FIGS. 7-9, a cleaning tool for a grease fitting includes a hand-held portion 1 and a cleaning portion 2, where the hand-held portion 1 and the cleaning portion 2 are integrally formed.

The cleaning portion 2 is arranged at one end of the hand-held portion 1, a center of an end face of the cleaning portion 2 is provided with a press bump 21, the periphery of the press bump 21 is provided with several cleaning claws 22, the press bump 21 presses a hole plugging ball 31 of the grease fitting 3, and the cleaning claw 22 has a longer length than the press bump 21 for cleaning the grease fitting 3.

An inner side of a cleaning claw 22 is a cambered surface 24, and fits a shell of the grease fitting 3 in shape.

At least two cleaning claws 22 are arranged, and preferably, three cleaning claws 22 are arranged. The cambered surfaces 24 are arranged to incline in the same direction in an axial direction. Since there is much grease on the grease fitting, inclined arrangement can reduce a resistance and the cleaning claw 22 can be made to rotate more easily. Similar to a principle of thread, more convenient rotation is achieved.

The cambered surfaces 24 include a first cambered surface 241 and a second cambered surface 242 connected to the first cambered surface 241, the first cambered surface 241 extends away from an axis in a direction far away from the hand-held portion 1, and the second cambered surface 242 extends close to the axis in the direction far away from the hand-held portion 1. The first cambered surface 241 and the second cambered surface 242 are better adapted to the grease fitting 3, such that wrapping at a larger area can be achieved, a better cleaning effect is achieved, and the cambered surface 24 is made not to be separated easily from the grease fitting 3.

The cleaning claws 22 are arranged to incline in the same direction in the axial direction. During rotation, the resistance can be reduced, such that the cleaning claw 22 can rotate more easily.

An end, far away from the hand-held portion 1, of the cleaning claw 22 is provided with an inclined surface 221. When the tool rotates, the grease can be discharged in time along with the inclined surface 221., such that the resistance is smaller, and the tool is convenient to use at a high rotation speed, generates less heat and has a longer service life.

The other end, relative to the cleaning portion 2, of the hand-held portion 1 is provided with a hollowed interior, and a hexagonal inner hole 11 is provided inside the hollowed interior. The hexagonal inner hole 11 can be used as a small wrench, and can also be connected to an electric wrench for automatic use.

EXAMPLE 5:

In Examples 1-4, it is necessary to clean the grease fitting 3 by manually screwing the hand-held portion 1, but manual screwing is limited in speed and laborious. As a result, in this example, an extension portion 4 and a press portion 5 are added on the basis of Example 4, and the extension portion 4 is rotated by pressing the press portion 5 to drive the cleaning portion 2. to clean the grease fitting 3. The way is labor-saving and more convenient in use.

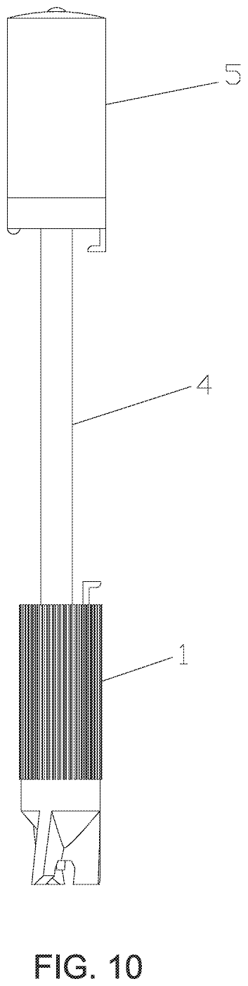

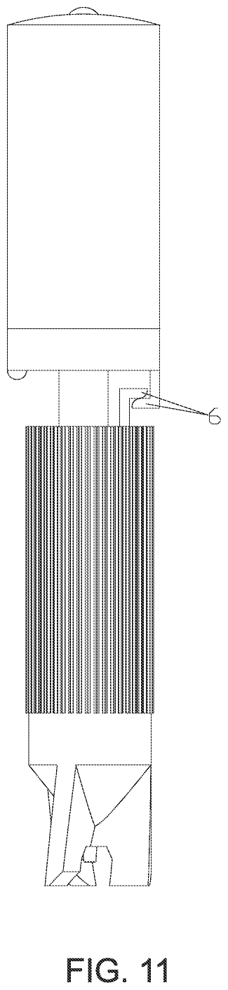

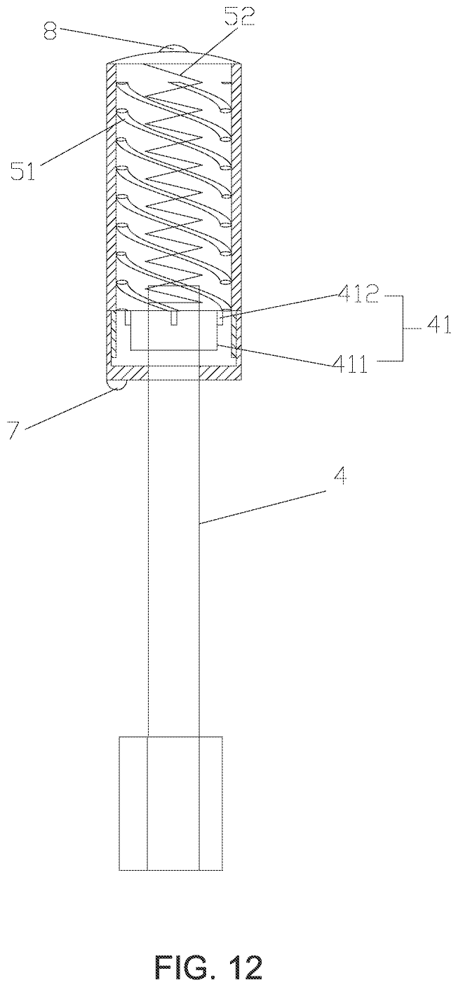

With reference to FIGS. 10-12, a cleaning tool for a grease fitting further includes an extension portion 4, one end of the extension portion 4 is detachably arranged in the hexagonal inner hole 11, the other end of the extension portion 4 is connected to a press portion 5, and under the condition that the press portion 5 moves close to the hand-held portion 1, the extension portion 4 rotates into the press portion 5. A manual pressing mode is easier to operate, faster in rotation speed and cleaner in cleaning than manual screwing of the hand-held portion 1. A head of the cleaning tool for a grease fitting, that is, the hand-held portion, is finely processed with PA66 material, and the design is detachable, and is convenient to flexibly use on a manual or pneumatic or electromechanical gun. Sand outside the grease fitting is prevented from running into the grease fitting, service lives of a machine and the grease fitting are greatly prolonged, and environmental protection and money saving effects are achieved.

In an alternative example, an interior of the press portion 5 is hollowed, an inner wall of the press portion 5 is provided with a plurality of spiral portions 51, an extension portion 4 is provided with a rotary portion 41, and the rotary portion 41 moves along the spiral portion 51 and drives the extension portion 4 to rotate. The rotary portion 41 includes a convex ring 411, a movable protrusion 412 is arranged in a peripheral direction of the convex ring 411, a spring 52 is further arranged inside the press portion 5, and an end of the spring 52 sleeves the extension portion 4.

Specifically, four movable protrusions 412 and four spiral portions 51 are in one-to-one correspondence. The spiral portion 51 provides a movement track for a movable protrusion 412. In order to facilitate entry of the movable protrusion 412, an initial opening of the spiral portion 51 is relatively large. In order to prevent the movable protrusion 412 from running out of the track, a tail end of the spiral portion 51 is closed. When the press portion 5 is pressed, the movable protrusion 412 slowly enters a bottom of the press portion 5 along the spiral portion 51, and in this case, the extension portion 4 rotates and compresses the spring 52 simultaneously. One end of the extension portion 4 is an external hexagon, and just engages with the hexagonal inner hole 11 of the hand-held portion 1. When the extension portion 4 rotates, the cleaning portion 2 may be driven to rotate and clean the grease fitting 3. When no force is exerted, the spring 52 may push the movable protrusion 412 away from the bottom of the press portion 5, and the hand-held portion 1 may rotate reversely to clean the grease fitting 3. A rotation speed of the hand-held portion 1 can be controlled according to a pressing speed.

In an alternative example, the press portion 5 and the hand-held portion 1 are connected to each other through a snap fastener 6, a lamp 7 is arranged at an end, close to the hand-held portion 1, of the press portion 5, and a switch 8 for controlling the lamp 7 is further arranged on the press portion 5.

Specifically, in order to facilitate transportation, the press portion 5 and the hand-held portion 1 are connected to each other through the snap fastener 6, The snap fastener 6 can be accommodated in the press portion 5 or the hand-held portion 1, so as to prevent collision during cleaning of the grease fitting 3. The snap fastener 6 has certain elasticity, facilitating buckling, In order to see the grease fitting 3 better, the lamp may also be controlled by the switch 8, causing higher convenience in an actual use process.

It should be noted that although the above examples have been described herein, the patent protection scope of the present invention is not limited. As a result, based on an innovative idea of the present invention, modifications and changes to the examples described herein, or equivalent structure, equivalent flow or equivalent function transformations by using the contents of the description and the accompanying drawings of the present invention, and direct or indirect applications of the above technical solution to other related technical fields shall be included in the protection scope of patent for the present invention.

What is claimed is:

1. A cleaning tool for a grease fitting, comprising a hand-held portion (1) and a cleaning portion (2), wherein the hand-held portion (1) and the cleaning portion (2) are integrally formed; and
the cleaning portion (2) is arranged at one end of the hand-held portion (1), and an inner side of a cleaning claw (22) is a cambered surface (24), and fits a shell of the grease fitting (3) in shape.

2. The cleaning tool for a grease fitting according to claim 1, wherein a center of an end face of the cleaning portion (2) is provided. with a press bump (21), the periphery of the press bump (21) is provided with several cleaning claws (22), the press bump (21) presses a hole plugging ball (31) of the grease fitting (3), and the cleaning claw (22) has a longer length than the press bump (21) for cleaning the grease fitting (3).

3. The cleaning tool for a grease fitting according to claim 2, wherein at least two cleaning claws (22) are provided, and cambered surfaces (24) are arranged to incline in the same direction in an axial direction.

4. The cleaning tool for a grease fitting according to claim. 3, wherein the cambered surfaces (24) comprise a first cambered surface (241) and a second cambered surface (242) connected to the first cambered surface (241), the first cambered surface (241) extends away from an axis in a direction far away from the hand-held portion (1), and the second cambered surface (242) extends close to the axis in the direction far away from the hand-held portion (1).

5. The cleaning tool for a grease fitting according to claim 3, wherein the cleaning claws (22) are arranged to incline in the same direction in the axial direction.

6. The cleaning tool for a grease fitting according to claim 3, wherein an end, far away from the hand-held portion (1), of the cleaning claw (22) is provided with an inclined surface (221).

7. The cleaning tool for a grease fitting according to claim I, wherein the other end, relative to the cleaning portion (2), of the hand-held portion (1) is provided with a hollowed interior, and a hexagonal inner hole (11) is provided inside the hollowed interior.

8. The cleaning tool for a grease fitting according to claim 1, wherein
at least three cleaning claws (22) are provided, and the cleaning claws (22) are symmetrically arranged and uniformly arranged at the periphery of a press bump (21).

9. The cleaning tool for a grease fitting according to claim 1, wherein
the hand-held portion (1) has a round appearance, the cleaning portion (2) is provided with a transverse beam (23), and a press bump (21) is arranged in a center of the beam (23).

10. The cleaning tool for a. grease fitting according to claim 1, wherein
an outer surface of the hand-held portion (1) is provided with raised strips (12), and the raised strips (12) are uniformly arranged on an outer surface of the hand-held portion (1) peripherally.

11. The cleaning tool for a grease fitting according to claim 1, wherein
the hand-held portion (1) has a hexagonal appearance, the cleaning portion (2) is provided with a transverse beam (23), and a press bump (21) is arranged in a center of the beam (23).

12. The cleaning tool for a grease fitting according to claim 7, further comprising an extension portion (4), wherein one end of the extension portion (4) is detachably arranged in the hexagonal inner hole (11), the other end of the extension portion (4) is connected to a press portion (5), and under the condition that the press portion (5) moves close to the hand-held portion (1), the extension portion (4) rotates into the press portion (5),

13. The cleaning tool for a. grease fitting according to claim 7, wherein an interior of the press portion (5) is hollowed, an inner wall of the press portion (5) is provided with a plurality of spiral portions (51), an extension portion (4) is provided with a rotary portion (41), and the rotary portion (41) moves along the spiral portion (51) and drives the extension portion (4) to rotate.

14. The cleaning tool for a grease fitting according to claim 13, wherein the rotary portion (41) comprises a convex ring (411), a movable protrusion (412) is arranged in a peripheral direction of the convex ring (411), a spring (52) is further arranged inside the press portion (5), and an end of the spring (52) sleeves the extension portion (4).

15. The cleaning tool for a grease fitting according to claim 12, wherein the press portion (5) and the hand-held portion (1) are connected to each other through a snap fastener (6), a lamp (7) is arranged at an end, close to the hand-held portion (1), of the press portion (5), and a switch (8) for controlling the lamp (7) is further arranged on the press portion (5).
